(19) United States
(12) Patent Application Publication
(10) Pub. No.: US 2024/0208862 A1
(43) Pub. Date: Jun. 27, 2024

(54) POLYACRYLIC ACID GRINDING AID FOR ENHANCED CEMENT POWDER FLOWABILITY

(71) Applicant: GCP Applied Technologies Inc., Alpharetta, GA (US)

(72) Inventors: Joshua Detellis, Woburn, MA (US); Jeffrey S. Thomas, Winchester, MA (US); Josephine H. Cheung, Lexington, MA (US)

(21) Appl. No.: 18/390,613

(22) Filed: Dec. 20, 2023

Related U.S. Application Data
(60) Provisional application No. 63/433,976, filed on Dec. 20, 2022.

(51) Int. Cl. C04B 7/52; C04B 16/04

(52) U.S. Cl. CPC C04B 7/52; C04B 16/04; C04B 2103/50

(57) ABSTRACT

A method for grinding cement clinker particles, comprising: introducing to a composition comprising dry cement clinker particles, in a ball mill or roller mill, whereby said particles are ground to have a finer average particle size, an aqueous grinding additive composition comprising: from about 0.1 to about 15% by weight of at least one polyacrylic acid or a salt thereof; and water; and grinding the dry composition comprising the cement clinker particles and the aqueous grinding additive composition to produce a cement product having a pack set index (PSI) greater than that obtained when the polyacrylic acid is not present in the grinding additive.

### FIELD OF THE INVENTION

The present invention relates to methods and compositions pertaining to the grinding of cement and cementitious materials, such as cement clinker to produce cement, raw materials for making cement clinker, blast furnace slag, and other particulates; and, more particularly, to the use of chemical additives to enhance the properties of finished cement, more specifically to adjust the flowability of the dry cement powder to make it easier to handle and transport.

### BACKGROUND OF THE INVENTION

In the process of manufacturing hydraulic cements such as Portland cement, a grinding operation is used to reduce cement particles to relatively smaller particle sizes. A granular starting material called “clinker,” which essentially consists of hydraulic calcium silicates, calcium aluminates, and calcium aluminoferrite, is mixed with small amounts of gypsum and ground into finely divided particles. As the grinding of clinker to produce the cement consumes substantial quantities of time and energy, it is common practice in the cement industry to employ grinding aids which increase the efficiency of the grinding operation, thereby lowering the power required to grind a unit of cement and increasing the rate of output of cement to accommodate high cement demands.

The beneficial use of grinding aids in the cement manufacturing process are well documented, with some of the main benefits including an increase in mill production rate, a decrease in specific energy consumption, and increase in cement powder flowability. The latter property of flowability is the subject of this invention. Some cement additives also contain chemicals that have the additional benefit of increasing the strength of the resulting concrete. Such strength-enhancing cement additives are often referred to as quality improvers.

The industrial standard for measuring cement flowability is the pack set index (PSI) test according to ASTM C1565, which results in a unitless number that indicates how difficult it is for the cement powder to start flowing from a static state. When the cement has a high PSI value (e.g., >10) it will be difficult to initiate flow, which will make it difficult to conduct conveying and transport operations. Cement with low PSI values (e.g., 0-4) will start to flow quite easily. However, when a cement has too low of a PSI, it also creates challenges for effective handling. For example, a cement with a very low PSI may start to flow backwards when transported on an upward-tilted conveyor belt. Also, cements with a low PSI tend to emit excessive fine dust when transported, which is an inconvenience and a health hazard. Cement manufacturers therefore typically try to maintain the flowability of their cement in a middle region of PSI for optimum handling.

Cements produced without a grinding aid will typically have a PSI value that is too high. The use of a cement grinding aid will decrease the PSI of a cement, making it easier to handle during conveying, loading for transportation, and unloading after transportation. The higher the dose of the grinding aid, the more the PSI will be reduced. If the dose is too high, then the PSI can become too low, and will exhibit the disadvantages noted above. This creates an upper limit on the grinding aid dose that may limit the other benefits that the grinding aid may provide. For example, a cement manufacturer may wish to use a higher grinding aid dosage in order to further increase the rate of mill production and/or further lower the specific energy consumption but be unable to do so because the PSI will then be too low.

It would be advantageous in certain situations to include in the grinding aid formulation one or more components that tend to decrease the flowability of the cement, to prevent the PSI from becoming too low when the grinding aid is used at higher dosages.

### SUMMARY OF THE INVENTION

The present invention provides compositions and methods for achieving optimal PSI for cement powders. In one aspect, disclosed herein is a method for grinding cement clinker particles, comprising introducing an aqueous grinding additive to a dry composition comprising cement clinker particles, in a ball mill or roller mill, whereby said particles are ground to have a finer average particle size, wherein the aqueous grinding additive composition comprises from about 0.1 to about 15% by weight of at least one polyacrylic acid or a salt thereof, wherein the polyacrylic acid has a weight average molecular weight of from 1,500 to 75,000 g/mol; and water; and grinding the dry composition comprising the cement clinker particles and the aqueous grinding additive composition to produce a cement product having a pack set index (PSI) greater than that obtained when the polyacrylic acid is not present in the grinding additive.

In another aspect, disclosed herein is a method for grinding cement clinker particles, comprising determining the PSI of ground cement powder after the cement powder was ground in the presence of a grinding aid that did not comprise a polyacrylic acid polymer and adding polyacrylic acid to the grinding aid in an amount effective to increase the PSI greater than that obtained when the polyacrylic acid is not present in the grinding additive; introducing an aqueous grinding additive to a dry composition comprising cement clinker particles, in a ball mill or roller mill, whereby said particles are ground to have a finer average particle size, wherein the aqueous grinding additive composition comprises: from about 0.1 to about 15% by weight of at least one polyacrylic acid or a salt thereof, wherein the polyacrylic acid has a weight average molecular weight of from 1,500 to 75,000 g/mol; and water; and grinding the dry composition comprising the cement clinker particles and the aqueous grinding additive composition to produce a cement product having a pack set index (PSI) greater than that obtained when the polyacrylic acid is not present in the grinding additive.

Further advantages and features of the invention will be discussed hereinafter.

### DETAILED DESCRIPTION OF EXEMPLARY EMBODIMENTS

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means±15% of the numerical value. In exemplary embodiments, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k (RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

The term “grinding” shall include milling or comminution of particles to reduce their average size and to increase the surface area per unit mass of material. Methods of the invention for grinding particles include the use of rotating ball mills in which the particles are pulverized. The methods may also involve mills which employ rollers (rotating cylinders) for crushing the particles. For example, the rollers may be used in a paired, nipped configuration, through which the particles are passed and crushed. The rollers may alternatively be used upon a horizontal surface, such as a circular table, on which a bed of particles is crushed as the rollers are rotated over the table surface.

The term “particles” as used herein includes hydratable cement and cement clinker which is ground, often with gypsum and calcium sulfate, to produce hydratable cement. The present invention not only concerns the grinding of clinker to produce cement, and the grinding of cement particles into still finer particles, but also the grinding of the raw materials which go into the production of the cement clinker. Such raw materials are commonly known to include calcite, limestone, aragonite, seashells, marl, limonite, clay, shale, sand, and bauxite.

The term “cement” or “cement product” as used herein includes hydratable Portland cement powder which is produced by pulverizing clinker consisting of hydraulic calcium silicates and one or more forms of calcium sulfate (e.g., gypsum) as an interground additive. The term “cementitious” as used herein refers to materials that comprise Portland cement or which otherwise function as a binder to hold together fine aggregates (e.g., sand), coarse aggregates (e.g., crushed gravel), or mixtures thereof.

Included in the definition of cement and cementitious materials, and often referred to as supplemental cementitious materials, are fly ash, granulated blast furnace slag, limestone, silica fume, calcined clay, natural pozzolans, or mixtures of these materials. Typically, Portland cement is combined with one or more other cementitious materials, such as the foregoing supplemental cementitious materials, and provided as a blend. The cement additive composition and method of the present invention, however, can be used separately for grinding Portland cement, or any of the other cementitious materials, independently, or in any combination.

For purposes of this disclosure, the term “Portland cement” is intended to include all cementitious compositions meeting the requirements of the ASTM (as designated by ASTM Specification C150). Portland cement is prepared by sintering a mixture of components including calcium carbonate (as limestone), aluminum silicate (as clay or shale), silicon dioxide (as sand) and miscellaneous iron oxides. During sintering, chemical reactions take place wherein hardened nodules, commonly called clinkers, are formed. Portland cement clinker is formed by the reaction of calcium oxide with acidic components to give primarily tricalcium silicate, dicalcium silicate, tricalcium aluminate, and a ferrite solid solution phase approximating tetracalcium aluminoferrite (C₄AF).

Portland cement clinker is a partially fused mass primarily composed of hydratable calcium silicates. The calcium silicates are essentially a mixture of tricalcium silicate (3CaO·SiO₂ “C₃S” in cement chemists' notation) and dicalcium silicate (2CaO·SiO₂, “C₂S”) in which the former is the dominant form, with lesser amounts of tricalcium aluminate (3CaO·Al₂O₃, “C₃A”) and tetracalcium aluminoferrite (4CaO·Al₂O₃—Fe₂O₃, “C₄AF”). See e.g., Dodson, Vance H., Concrete Admixtures (Van Nostrand Reinhold, New York N.Y. 1990), page 1.

The term “hydratable” as used herein is intended to refer to cement or cementitious materials that are hardened by chemical interaction with water.

As used herein, the term “cement clinker” refers to a solid material produced in the manufacture of cement as an intermediary product prior to grinding. Portland cement clinker is made by feeding raw materials containing calcium, iron, silicon and aluminum into a kiln where they are heated to very high temperatures (e.g., 1500° C.). The heating causes the raw materials to fuse into clinker nodules that are mostly of diameter 3-25 mm (although finer and coarser nodules also occur).

Exemplary “liquid-additive compositions” of the present invention are described as a “liquid” form in that they can be sprayed onto the material to be ground using pressured nozzles and/or pumps. Water is preferably used to liquefy the low molecular weight fatty acid (e.g., potassium sorbate) and render it sprayable or injectable in liquid form into the material to be ground.

The compositions and methods of the present invention may be used with or in conventional grinding mills, such as ball mills (or tube mills). The present inventors also believe that they can be applied in mills employing rollers (e.g., vertical rollers, rollers on tables, etc.). See, e.g., U.S. Pat. No. 6,213,415 of Cheung, which is incorporated herein by reference in its entirety.

In one embodiment, the present invention is directed to a method for grinding cement clinker particles, comprising introducing an aqueous grinding additive to a dry composition comprising cement clinker particles, in a ball mill or roller mill, whereby said particles are ground to have a finer average particle size, wherein the aqueous grinding additive composition comprises from about 0.1 to about 15% by weight of at least one polyacrylic acid or a salt thereof, wherein the polyacrylic acid has a weight average molecular weight of from 1,500 to 75,000 g/mol; and water; and grinding the dry composition comprising the cement clinker particles and the aqueous grinding additive composition to produce a cement product having a pack set index (PSI) greater than that obtained when the polyacrylic acid is not present in the grinding additive.

In another embodiment, the present invention is directed to a method for grinding particles, comprising: introducing to a dry composition comprising cement clinker particles, in a ball mill or roller mill, whereby said particles are ground to have a finer average particle size, an aqueous grinding additive composition comprising: from about 0.5 to about 60% by weight of at least one polycarboxylate ether comb polymer; from about 0.1 to about 15% by weight of at least one polyacrylic acid or salt thereof, wherein the polyacrylic acid has a weight average molecular weight of from 1,500 to 75,000 g/mol; and water; and grinding the dry composition comprising the cement clinker particles and the aqueous grinding additive composition to produce a cement product having a pack set index (PSI) greater than that obtained when the polyacrylic acid is not present in the grinding additive.

The present invention is also directed to an aqueous additive composition comprising from about 0.5 to about 60% by weight of at least one polycarboxylate ether comb polymer; from about 0.1 to about 15% by weight of at least one polyacrylic acid or salt thereof, wherein the polyacrylic acid has a weight average molecular weight of from 1,500 to 75,000 g/mol; and water. The method disclosed herein applies the aqueous additive compositions disclosed herein to a cement clinker grinding process.

The method for grinding particles disclosed herein comprises the step of introducing to a dry composition comprising cement clinker particles, in a ball mill or roller mill, whereby said particles are ground to have a finer average particle size, an aqueous grinding additive composition comprising from about 0.1 to about 15% by weight of at least one polyacrylic acid or salt thereof, wherein the polyacrylic acid has a weight average molecular weight of from 1,500 to 75,000 g/mol.

Grinding additives disclosed herein are preferably liquid and, thus, comprise water. Weight percentages disclosed below are based on the non-diluted active component (i.e., ready for use). As mentioned above, the aqueous grinding additive compositions disclosed herein comprise from about 0.1 to about 25% by weight, preferably from about 1 to 15%, more preferably from about 1 to about 10%, even more preferably from about 2 to about 8% by weight, and most preferably from about 3 to 5% by weight of at least one polyacrylic acid, which includes the acid, partial or complete neutralization of the acids to form salts of polyacrylic acid such as, for example, alkali metal salts and/or ammonium salts. The term “polyacrylic acid” as used herein means homopolymers of acrylic acid and copolymers of acrylic acid with an ethylenically co-polymerizable monomers such as, for example, ethylene propylene, butadiene, styrene, methacrylic acid and the like. The co-polymerizable monomers are normally present in up to 30 mole percent, preferably up to 20 mole percent. The preferred agents are homopolymers of acrylic acid and homopolymers of acrylic acid which are partially to fully neutralized with an alkali metal base, such as the sodium salt of polyacrylic acid.

The polyacrylic acid component of the grinding aid composition preferably has a weight average molecular weight of at least about 1,500 to 500,000 g/mol weight average molecular weight as determined by gel permeation chromatography (GPC). In some embodiments, the weight average molecular weight of the polyacrylic acid polymer is in the range of from 100,000 to 500,000 g/mol. In other embodiments, the molecular weight of the polyacrylic acid polymer is in the range of from 40,000 to 100,000 g/mol. In yet other embodiments, the molecular weight of the polyacrylic acid polymer is in the range of from 1,500 to 75,000 g/mol. In still other embodiments, the weight average molecular weight of the polyacrylic acid polymer is in the range of from 1,500 to 50,000 g/mol and, preferably, from 1,500 to 25,000 g/mol. Lower molecular weights (e.g., 1,500 to 50,000 g/mol) are preferred due to cost and viscosity control of the liquid grinding aid.

The polyacrylic acid component functions to counteract the flowability of the cement powders once ground to reduce the flowability (increasing the PSI) of the finished cement at a given additive dosage to make the cement powder easier to handle and transport.

In some embodiments, the polyacrylic acid comprises the following structure:

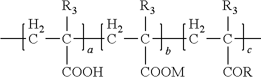

wherein
each R₃ is individually selected from hydrogen or methyl;
R is selected from a C₁-C₃ alkoxy or NH₂;
M is an alkali metal;
x, y and z are integers such that z is from 0 to less than 0.3 of the total of x+y+z; and
x+y+z is a sum of the integers to represent a low molecular weight polymer of from about 5,000 to 500,000.

The polyacrylic acid component can be formed by conventional techniques known to those skilled in the art such as by solution polymerization in which free radical polymerization of the monomer or monomers is conducted in isopropanol or isopropanol-water solvent at 120° C. to 200° C. under pressure as disclosed in German patent application No. 2,757,329, which is incorporated herein by reference. The free carboxylic acid groups of the polyacrylic acid are formed into an alkali metal salt with an alkali metal hydroxide or the like in sufficient amount to cause a resultant aqueous solution of the polymer to have a pH of from at least about 6 to about 10 and preferably from about 7 to 8.

Exemplary compositions and methods of the present invention comprise the use of the at least one polyacrylic acid in the amount of 0.0005-0.04 percent based on dry weight of the cementitious material being ground.

In some embodiments, the grinding additive compositions disclosed herein comprise at least one polycarboxylate ether comb polymer. Polycarboxylate ether comb polymers are known to be used in cement grinding aid compositions and they are known to be particularly effective in reducing the amount of water added during the grinding process. Polycarboxylate ether comb polymers are particularly suitable for use in combination with polyacrylic acid because when used in grinding aid compositions for grinding cement clinker and other cementitious compositions, polycarboxylate ether comb polymers alone tend to make resulting cement powders with a low PSI, e.g., from 0 to 4, thus causing problems with dusting and transportation of the cement powder.

In embodiments, the at least one polycarboxylate ether comb polymer has a structure represented by Formula (I) or Formula (II):

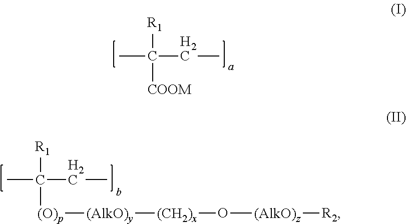

wherein each R₁ independently represents a hydrogen atom or a methyl group (—CH₃ group);
M represents hydrogen atom, an alkali metal or an alkaline earth metal cation, ammonium or organic amine groups or a mixture thereof;
Alk represents a C₂-C₁₀ alkylene group;
p represents an integer of 0-1;
x represents an integer of 1-10;
y represents a number of 0-300;
z represents a number of 1-300:
R₂ represents a hydrogen atom or a hydrocarbon group having 1-10 carbon atoms; and
“a” and “b” are numerical values representing molar percentage of the polymer's structure, wherein “a” is 30-90 and b is 10-70.

The term “integer” refers to natural numbers including zero, while the term “number” includes whole numbers as well as fractions or decimal portions thereof.

In some embodiments, the alkylene oxide (AlkO) group or groups is preferably comprised of ethylene oxide (“EO”), propylene oxide (“PO”), or mixture thereof, wherein the molar percentage ratio of EO:PO is 90:10 to 100:0. Most preferred are AlkO groups having 100% ethylene oxide.

In some embodiments, the alkyl group (CH₂)ₓ shown in structural formula (II) above is preferably located adjacent or close to the ether linkage shown in structural formula (II) above.

In some embodiments, R₂ in structure (II) represents hydrogen atom or a hydrocarbon group having 1-4 carbon atoms; x represents an integer of 1 to 4; y represents a number of 0; and z represents a number of 5-300.

In some embodiments, R₂ in structure (II) represents hydrogen atom or a methyl group (—CH₃ group); and z represents a number of 10-300.

In other embodiments, the at least one polycarboxylate ether comb polymer is a polymer comprising a hydrocarbon-containing main chain carrying carboxylic groups and polyalkyl chains and 0.01 to 4% by weight relative to the weight of the final polymer of antioxidant groups grafted to the main chain. Preferably, the antioxidant groups comprise an aromatic amine, especially an amine bearing two aromatic substituents, also bearing a reactive function allowing grafting, such as 4-aminodiphenylamine. Particularly preferred is a group derived from an antioxidant compound of formula (III) below:

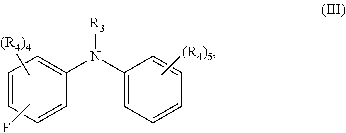

wherein R₃ is hydrogen or a saturated or unsaturated, straight or branched hydrocarbon-based chain, or one or more optionally fused aromatic rings, comprising 1 to 100 carbon atoms optionally interrupted by one or more heteroatoms such as O, S, N or P, preferably R₃ is hydrogen;
R₄ is independently of each other, selected from hydrogen or a straight or branched hydrocarbon chain, saturated or unsaturated, or one or more optionally fused aromatic rings, comprising 1 to 100 carbon atoms, optionally interrupted by one or several heteroatoms such as O, S, N or P, and/or optionally substituted by one or more amine, alcohol, ketone, halogenated derivative, isocyanate, acetoacetonate, silanol, carboxylic acid ester and alcohol, epoxide, carbonate or mercaptan, phosphate, phosphonate, sulfate, sulfonate or carboxylate, preferably R₃ is hydrogen; and
F is an amino group, especially a primary amine, alcohol, ketone, halogenated derivative, isocyanate, acetoacetonate, silanol, carboxylic acid ester and alcohol, epoxide, carbonate or mercaptan linked to the aromatic ring optionally by a straight or branched hydrocarbon chain, saturated or unsaturated having up to 100 carbon atoms, preferably F is a primary amino group.

The antioxidant compound is grafted onto the polymer by reaction of the reactive function of the PCE polymer. Advantageously, the antioxidant group may in particular be grafted onto the main chain via a carboxylic group, by means of an amide or ester bond. The antioxidant group may however also be grafted by any other type of covalent bond. The graft polymer according to the invention preferably has a weight average molecular weight (Mw) of between 1,000 and 1,000,000 g/mol, preferably between 5,000 and 10,000 g/mol. In a preferred order, the polymer is in powder form. Such polycarboxylate ether comb polymers are disclosed in international patent application publication WO 2013/021029, which is incorporated herein by reference in its entirety.

The above polycarboxylate ether comb polymers preferably have a weight average molecular weight of 5,000 to 1,000,000 as determined be gel permeation chromatography (“GPC”) on the polyethylene glycol equivalent basis. The weight average molecular weight (Mw) here and below is determined by GPC, wherein polyethylene glycol (PEG) is used as standard.

The proportion of the polycarboxylate ether in the grinding additive composition can vary in broad ranges. Typically, the proportion of the polycarboxylate ether is, for example, 5 to 90% by weight and, preferably, 10 to 50% by weight, relative to the weight of the aqueous composition.

Exemplary compositions and methods of the present invention comprise the use of a polycarboxylate comb polymer in the amount of 0.002-0.4 percent based on dry weight of the cementitious material being ground.

Exemplary compositions and methods of the invention may employ additional conventional cement grinding additive components such as amines, alkanolamines, glycols, or mixture thereof. Preferred additives include, without limitation, triethanolamine, triisopropanolamine, diethanolisopropanolamine, diisopropanolethanolamine, tetrahyroxyethylthylene diamine, an acetic acid or salt thereof, or mixtures thereof.

Preferred glycols include at least one selected from the group consisting of ethylene glycol, diethylene glycol, triethylene glycol, dipropylene glycol, and tripropylene glycol.

In some embodiments, glycerin may be employed in exemplary embodiments to enhance the ability of the liquid-applied grinding additive composition to coat the particles during grinding. Glycerin refers to 1,2,3-propane triol.

The preparation of the grinding additive composition occurs by adding the components to water in the desired amounts. Depending on the type of the polycarboxylate ether, a dispersion or a solution forms. A solution is preferred.

In some embodiments, the grinding additive composition disclosed herein further comprises at least one of a glycol, glycerol, sugar, salt, a defoamer, and acetic acid or an acetate salt.

In some embodiments, the sugar content is from 0.1-50% by weight, the salt content is from 0.1-50% by weight, the defoamer content is from 0.05-10% by weight, and the acetic acid and/or acetate salt content is from 0.1-50% by weight of the grinding additive. The sugar can be at least one selected from the group of sucrose, gluconic acid and/or salt thereof, corn syrup, and molasses. The salt can be at least one selected from the group consisting of sodium and/or calcium chloride, sodium thiocyanate, and calcium nitrate.

Finally, exemplary compositions and methods of the invention further involve the use of water, which should be present in an amount of from 10 to 95.0 percent, and more preferably 20.0 to 60.0 percent, based on total weight of the cement grinding additive composition. Preferably, the amount of water is the remainder totaling to 100% after the amounts of the other components are accounted for on an active/solid basis. This means that the invention covers concentrated forms wherein the cement grinding additive composition is nearly water-free, such that it would not allow for solubilization or complete solubilization of the soluble components, such that the cement additive product can be shipped to the cement manufacturer customer with a high viscosity, and the customer can subsequently add water to dilute the product in “day tanks” if needed.

The amount of grinding additive can vary within wide limits, but preferably 0.001 to 1.0% by weight (of additive solids) and more particularly 0.005 to 0.15% by weight of grinding aid is used, based on the weight of the mineral solids (i.e., “solids on solids” or “s/s”) that are subjected to grinding. There is no upper limit for the added grinding aid quantity, but, in general, only that quantity required for obtaining the desired surface area in the most efficient mill operation is added.

Aqueous grinding additive compositions as disclosed herein are typically introduced to the cement clinker to be ground by spraying or dripping the composition, prior to, or during grinding. The addition of the grinding aid compositions disclosed herein can occur before or at the mill inlet or directly in the mill, preferably before or at the mill inlet. In embodiments, the particles to be ground comprise cement and at least one of fly ash, granulated blast furnace slag, limestone, calcined clay, or natural pozzolan.

As summarized above, an exemplary method for grinding particles, comprises introducing to a composition comprising dry cement clinker particles, in a ball mill or roller mill, whereby said particles are ground to have a finer average particle size, an aqueous grinding additive composition as disclosed above; and grinding the composition comprising cement clinker and the aqueous grinding additive composition.

It should be noted that while the disclosure above includes PCE in the composition, the application of the polyacrylic acid as a powder flowability limiter could have wider applicability to any situation where the flowability of a powder is higher than is desired. For example, a manufacturer using a glycol-based grinding aid may wish to use a very high dosage to maximize production but finds that the PSI is too low. Thus, a combination of glycol and PAA could be provided.

The method of the present invention includes the step of grinding the composition comprising the dry cement clinker particles and the aqueous grinding additive composition to produce a cement product having a pack set index (PSI) greater than that obtained when the polyacrylic acid is not present in the grinding additive.

The pack set index (PSI) can be determined by ASTM C1565. The pack set index is a relative term which numerically indicates the proclivity of a particular cement to pack set when it is stored in or transported in bulk. Variations of the ASTM C₁₅₆₅ may also be performed but, either way, the same method should be used to consistently measure the PSI of the cement powder before and after polyacrylic acid is added to the grinding additive. In one variation, the pack set index is obtained in the following manner: 100 grams of cement are placed in a 250 mL Erlenmeyer flask set on top of a variable vibrator. The flask containing the cement is vibrated for 15 seconds after which time it is removed from the vibrator and carefully placed in a jig with the axis of the flask lying horizontally. The flask is then rotated around its axis until the compacted cement collapses. The flask is twisted by turning at 180° angles at approximately 40 twists per minute. The number of 180° twists required for the cement sample to collapse establishes the pack set index. Thus, the greater the energy required to break up the bed, the higher will be the pack set index. The pack set index obtained by this method correlates well with the field performance of the cement. The higher the pack set index of the particular cement, the more prone a larger volume of that cement is to pack set if maintained in bulk.

Cements are composed of main constituents, usually additionally of small quantities of calcium sulfate (gypsum and/or hemihydrate and/or anhydrite) and optionally of secondary constituents and/or cement additives such as grinding aids. Main constituents are used in quantities of more than 5% by weight. The main constituents can be Portland cement clinker, also referred to as clinker, slag sand, natural or synthetic pozzolans, fly ash, for example, siliceous or calcareous fly ash, burnt shale, limestone and/or silica fume. As secondary constituent, the cements can contain up to 5% by weight of finely divided inorganic, mineral substances, which originate from the clinker production, for example, raw meal, or correspond to the other main constituents.

The cement, for the preparation of which the grinding aid used according to the invention is used, can be any conventional cement, for example, one in accordance with the five main cement types according to DIN EN 197-1: namely, Portland cement (CEM I), Portland composite cements (CEM II), blast-furnace cement (CEM III), pozzolan cement (CEM IV) and composite cement (CEM V). These main cement types are subdivided, depending on the amount added, into an additional 27 cement types, which are known to the person skilled in the art and listed in DIN EN 197-1. Naturally, all other cements that are produced according to another standard are also suitable, for example, according to ASTM standard or Indian standard. To the extent that reference is made here to cement types according to DIN standard, this naturally also relates to the corresponding cement compositions which are produced according to another cement standard.

A preferred cement comprises, for example, a mixture of at least one hydraulic powder and one or more powders selected from nonhydraulic, latent hydraulic and pozzolanic powders. In some embodiments, the cement comprises pozzolanic clinker substitutes, for example, fly ash such as anthracite fly ash or lignite fly ash, or nonhydraulic clinker substitutes such as limestone, for example.

In the preparation of a cement, cement grinding occurs. The cement grinding is used in particular to form a reactive product from the clinker and optionally from the additional main constituents. For this purpose, the clinker alone, optionally jointly with secondary constituents (as a rule at most up to 5% by weight) or with additional main constituents, is finely milled. For the adjustment of the solidification, gypsum stone or a gypsum-anhydrite mixture is usually added to the milled product. In the case of joint grinding or fine grinding, the particle size distributions of the individual components cannot be influenced separately. For optimal cement production, separate grinding and subsequent mixing can therefore also be advisable, due to the different grindabilities of the cement raw materials.

In the method according to the invention for producing a cement, at least one or preferably all of the main cement constituents is/are milled in the presence of a grinding aid composition comprising a polyacrylic acid as disclosed herein, which is preferably an aqueous grinding aid, wherein the at least one main constituent preferably comprises the clinker. The cement grinding is a dry grinding process. After the grinding, the cement product is present in the form of a powder.

Secondary cement constituents, calcium sulfate and additional cement additives can be admixed before or after the grinding with the grinding aid, wherein they are preferably added before the grinding. To the extent that all the cement main constituents are not milled together in the presence of the grinding aid used according to the invention, the separately milled main cement constituents can be admixed later. Naturally, it is also possible to mill such separately milled main cement constituents likewise in the presence of the grinding aid used according to the invention.

The cement grinding usually occurs in mills, wherein ball mills, high pressure roll mills and vertical roll mills are preferable.

Typical cement grinding aids are dosage limited in their beneficial effect on grinding throughput due to cement powder becoming too flowable, e.g., having a pack set index (PSI) of from 0 to 4. The inventors surprisingly found that when polyacrylic acid or salts thereof (alkali metal or amine salt) is used in combination with conventional grinding aid chemistries that allow for higher cement grinding throughput rates, the combination of polyacrylic acid with these conventional grinding aid chemistries prevents the cement powder from becoming too flowable (i.e., increases the PSI), thus allowing for greater grinding throughput to be achieved and allowing the additives to be used at higher dosages without creating excess flowability. For example, when any particular grinding aid composition is added to a dry composition of clinker either just before or during the dry grinding process and the resulting cement powder has a PSI of from 0 to 4, polyacrylic acid as disclosed herein can be added to the grinding aid composition to increase the PSI of the cement powder to, for example, from greater than 4 to 9 in some embodiment, from greater than 4 to 8 in other embodiments, from greater than 4 to 7 in other embodiments, from greater than 4 to 6 in other embodiments, from 5 to 9 in some embodiment, from 5 to 8 in other embodiments, from 5 to 7 in other embodiments, and from greater than 5 to 6 in yet other embodiments. In other embodiments, a PSI of from 0-2 may be obtained for a cement powder ground with a grinding aid that does not include polyacrylic acid and it may be desired to increase the PSI to greater than 2 such as, for example, from greater than 2 to 6.

In one embodiment, a cement produced with a grinding additive free of polyacrylic acid has a PSI of less than 1 and when produced with a grinding additive including a polyacrylic acid having a weight average molecular weight of from 1,500 to 75,000 g/mol, the PSI increases to from greater than 1 to about 8. In another embodiment, a cement produced with a grinding additive free of polyacrylic acid has a PSI of less than 2 and when produced with a grinding additive including a polyacrylic acid having a weight average molecular weight of from 1,500 to 75,000 g/mol, the PSI increases to from greater than 2 to about 8. In another embodiment, a cement produced with a grinding additive free of polyacrylic acid has a PSI of less than 3 and when produced with a grinding additive including a polyacrylic acid having a weight average molecular weight of from 1,500 to 75,000 g/mol, the PSI increases to from greater than 3 to about 8. In another embodiment, a cement produced with a grinding additive free of polyacrylic acid has a PSI of less than 4 and when produced with a grinding additive including a polyacrylic acid having a weight average molecular weight of from 1,500 to 75,000 g/mol, the PSI increases to from greater than 4 to about 8. In another embodiment, a cement produced with a grinding additive free of polyacrylic acid has a PSI of less than 5 and when produced with a grinding additive including a polyacrylic acid having a weight average molecular weight of from 1,500 to 75,000 g/mol, the PSI increases to from greater than 5 to about 8. In yet another embodiment, a cement produced with a grinding additive free of polyacrylic acid has a PSI of less than 6 and when produced with a grinding additive including a polyacrylic acid having a weight average molecular weight of from 1,500 to 75,000 g/mol, the PSI increases to from greater than 6 to about 8.

One of ordinary skill in the art can readily determine whether a grinding aid composition is sufficiently effective at grinding a dry cement composition efficiently but wherein the resulting cement powder flows too readily such that it is difficult to transport. Thus, adding an amount of polyacrylic acid at the molecular weights disclosed herein will be effective to increase the PSI of the resulting dry cement product where it would otherwise be too low for a particular plant or application.

The method of the present invention optionally includes the steps of determining the PSI of ground cement powder after the cement powder was ground in the presence of a grinding aid that did not comprise a polyacrylic acid polymer and adding polyacrylic acid to the grinding aid in an amount effective to increase the PSI greater than that obtained when the polyacrylic acid is not present in the grinding additive. An example is a method for grinding cement clinker particles, comprising determining the PSI of ground cement powder after the cement powder was ground in the presence of a grinding aid that did not comprise a polyacrylic acid polymer and adding polyacrylic acid to the grinding aid in an amount effective to increase the PSI greater than that obtained when the polyacrylic acid is not present in the grinding additive; introducing an aqueous grinding additive to a dry composition comprising cement clinker particles, in a ball mill or roller mill, whereby said particles are ground to have a finer average particle size, wherein the aqueous grinding additive composition comprises: from about 0.1 to about 15% by weight of at least one polyacrylic acid or a salt thereof, wherein the polyacrylic acid has a weight average molecular weight of from 1,500 to 75,000 g/mol; and water; and grinding the dry composition comprising the cement clinker particles and the aqueous grinding additive composition to produce a cement product having a pack set index (PSI) greater than that obtained when the polyacrylic acid is not present in the grinding additive.

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by weight of the total liquid composition, unless otherwise specified.

### EXAMPLES

Example 1: The effect of PAA on flowability was tested in a laboratory using a commercial Portland cement produced with a glycol grinding aid. The cement was treated with PAA at a dosage of 50 ppm by weight of cement. The MW of the PAA was 345,000 g/mol. The PAA and cement were added to a sealed container which was then subjected to mixing for 30 minutes using a mixer (Turbula Mixer Model T2F) designed to disperse liquids onto powders. A sample of the as-received cement with no additive was also subjected to the same 30-minute mixing procedure. The pack set index of the untreated and PAA-treated samples was then measured according to ASTM C1565. The untreated sample had PSI=2 indicating a highly flowable cement, while the PAA-treated cement had PSI=6, a value that indicates a moderately flowable cement. The results in Table 1 show that addition of the PAA increased the PSI of the cement from 2 to 6.

TABLE 1

| Lab Treatment | PSI at 40 volts |
|---|---|
| untreated | 2 |
| PAA | 6 |

Example 2: The effect of different molecular weight PAA on flowability was tested in a laboratory ground cement using a combination of glycol and polycarboxylate ether as the grinding aid. Each cement was ground to the same fineness with the same amount of glycol and polycarboxylate ether. The lab mill used was a batch ball mill with dimensions of 52 cm length with a 52 cm diameter, and a ball charge of 59.1 kg. The reference cement had no PAA included with the grinding aid. The other cement samples were interground with 50 ppm on cement weight of different molecular weight PAAs. After grinding was complete, the pack set index for each cement was tested according to ASTM C1565. The results in Table 2 indicate that the 345 k MW and, more so, the 6 k MW PAAs increase the PSI compared to the reference cement. This result indicates the lower MW PAA is more effective at increasing the PSI of the cement. Interestingly, the 50 k MW PAA had minimal impact on the PSI, which may be due to this PAA being fully neutralized forming a sodium salt. The PAA samples used for the test were Carbosperse K-732 (6 k MW PAA), Carbosperse K-702 (345 k MW PAA), and the NAP 641 from Sikel Italia SpA (50 k MW fully neutralized PAA).

TABLE 2

| | Pack Set Index at 50 | |
|---|---|---|
| Cement Sample | volts | Standard Deviation |
| Reference | 6.0 | 0.7 |
| 6k MW PAA | 8.4 | 0.9 |
| 345k MW PAA | 7.4 | 0.9 |
| 50k MW fully neutralized | 6.2 | 0.4 |
| PAA | | |

Example 3: The impact of PAA on cement flowability was tested with a cement produced from lab ball mill grinding. The lab mill used was the Frisch planetary ball mill Pulverrisette 5. The reference cement was produced without use of grinding aids, while the second cement was produced with 50 ppm of 6 k MW PAA during grinding. Each cement was ground to the same fineness of about 360 m²/kg. As shown in Table 3 below, after five test runs for each sample, the cement treated with PAA has pack set index value 3 higher than the reference, thus indicating the PAA decreased the cement flowability in a cement without grinding aids.

TABLE 3

| | Pack Set | | |
|---|---|---|---|
| | Index at 50 | Standard | Standard |
| Cement | volts | Deviation | Error |
| Untreated Reference | 10.4 | 2.6 | 0.5 |
| PAA Treated | 13.4 | 4.8 | 1.0 |
| Cement | | | |

Example 4: The impact of PAA on cement flowability in a PCE based and amine-based grinding aid was tested with a cement produced from a lab ball mill grinder. The lab mill used was the Frisch planetary ball mill Pulverrisette 5 and the powder was ground to a fineness of about 420 m²/kg. Both the reference and PAA containing PCE based grinding aid contained 400 ppm PCE+300 ppm diethylene glycol+650 ppm water. All ppm values are based on cement weight. The addition of 50 ppm of PAA increased the pack set index of the cement treated with the PCE based grinding aid from 2.2 to 3.2, indicating the addition of PAA decreased the cement flowability. The amine-based grinding aid contained 200 ppm Triisopropanolamine+100 ppm sucrose+250 ppm sodium thiocyanate+650 ppm water. The addition of PAA to the amine-based grinding aid increased the pack set index of the cement by 1.0, indicating PAA is decreasing the flowability of the cement. The results of five test runs for each sample are shown in Table 4.

TABLE 4

| | Pack Set | | |
|---|---|---|---|
| | Index at 52 | standard | Standard |
| Cement | volts | Deviation | Error |
| PCE Based Reference | 2.2 | 0.4 | 0.09 |
| PCE Based with PAA | 3.2 | 0.8 | 0.17 |
| Amine Based Reference | 2.0 | 0 | 0 |
| Amine Based with PAA | 3.0 | 0 | 0 |

While the invention is described herein using a limited number of embodiments, these specific embodiments are not intended to limit the scope of the invention as otherwise described and claimed herein. Modification and variations from the described embodiments exist. More specifically, the foregoing examples are given as a specific illustration of embodiments of the claimed invention. It should be understood that the invention is not limited to the specific details set forth in the examples. All parts and percentages in the examples, as well as in the remainder of the specification, are by percentage weight unless otherwise specified.

What is claimed is:

1. A method for grinding cement clinker particles, comprising:
introducing an aqueous grinding additive to a dry composition comprising cement clinker particles, in a ball mill or roller mill, whereby said particles are ground to have a finer average particle size, wherein the aqueous grinding additive composition comprises:
from about 0.1 to about 15% by weight of at least one polyacrylic acid or a salt thereof, wherein the polyacrylic acid has a weight average molecular weight of from 1,500 to 75,000 g/mol; and
water; and
grinding the dry composition comprising the cement clinker particles and the aqueous grinding additive composition to produce a cement product having a pack set index (PSI) greater than that obtained when the polyacrylic acid is not present in the grinding additive.

2. The method of claim 1 wherein the aqueous grinding additive further comprises from about 0.5 to about 60% of at least one polycarboxylate ether comb polymer.

3. The method of claim 1 further comprising the steps of determining the PSI of ground cement powder after the cement powder was ground in the presence of a grinding aid that did not comprise a polyacrylic acid polymer and adding polyacrylic acid to the grinding aid in an amount effective to increase the PSI.

4. The method of claim 1 wherein the particles being ground comprise cement clinker and at least one of fly ash, granulated blast furnace slag, limestone, calcined clay, or natural pozzolan.

5. The method of claim 1 wherein the aqueous grinding additive composition further comprises at least one of a glycol, glycerol, a defoamer, sugar, salt, acetic acid or an acetate salt.

6. The method of claim 5 wherein glycol is present and the glycol comprises at least one selected from the group consisting of ethylene glycol, diethylene glycol, triethylene glycol, dipropylene glycol, and tripropylene glycol.

7. The method of claim 1 wherein the aqueous grinding additive composition further comprises a grinding additive selected from the group consisting of triethanolamine, triisopropanolamine, diethanolisopropanolamine, diisopropanolethanolamine, tetrahyroxyethylthylene diamine, an acetic acid or salt thereof, or mixtures thereof.

8. The method of claim 2 wherein the at least one polycarboxylate ether comb polymer has a structure represented by Formula (I) or Formula (II): 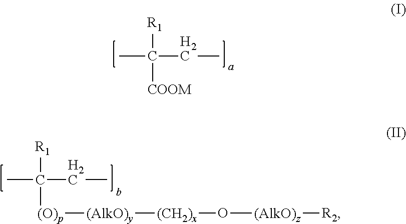
wherein each R₁ independently represents a hydrogen atom or a methyl group (—CH₃ group);
M represents hydrogen atom, an alkali metal or an alkaline earth metal cation, ammonium or organic amine groups or a mixture thereof;
Alk represents a C₂-C₁₀ alkylene group;
p represents an integer of 0-1;
x represents an integer of 1-10;
y represents a number of 0-300;
z represents a number of 1-300:
R₂ represents a hydrogen atom or a hydrocarbon group having 1-10 carbon atoms; and
“a” and “b” are numerical values representing molar percentage of the polymer's structure, wherein “a” is 30-90 and b is 10-70.

9. The method of claim 8 wherein the AlkO represents ethylene oxide (“EO”) and propylene oxide (“PO”), wherein the molar percentage ratio of EO:PO is 90:10 to 100:0.

10. The method of claim 8 wherein R₂ in structure (II) represents hydrogen atom or a hydrocarbon group having 1-4 carbon atoms; x represents an integer of 1 to 4; y represents a number of 0; and z represents a number of 5-300.

11. The method of claim 5 wherein the aqueous grinding additive comprises sugar at a concentration of from 0.1-50% by weight, salt at a concentration of from 0.1-50% by weight, the defoamer at a concentration of from 0.05-10% by weight, and acetic acid and/or acetate salt at a concentration of from 0.1-50% by weight.

12. The method of claim 5 wherein sugar is present and the sugar is at least one selected from the group consisting of sucrose, gluconic acid and/or salt thereof, corn syrup, and molasses.

13. The method of claim 5 wherein salt is present and the salt is at least one selected from the group consisting of sodium chloride, calcium chloride, sodium thiocyanate, and calcium nitrate.

14. The method of claim 2 wherein the at least one polycarboxylate ether comb polymer comprises a hydrocarbon-containing main chain carrying carboxylic groups and polyalkyl chains and 0.01 to 4% by weight relative to the weight of the polymer of antioxidant groups grafted to the main chain, wherein the antioxidant groups comprise an aromatic amine having the following structural Formula (III): 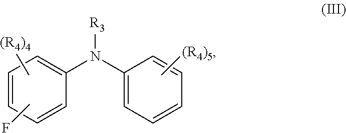
wherein R₃ is hydrogen or a saturated or unsaturated, straight or branched hydrocarbon-based chain, or one or more optionally fused aromatic rings, comprising 1 to 100 carbon atoms optionally interrupted by one or more heteroatoms such as O, S, N or P;
R₄ is independently of each other selected from hydrogen or a straight or branched hydrocarbon chain, saturated or unsaturated, or one or more optionally fused aromatic rings, comprising 1 to 100 carbon atoms, optionally interrupted by one or several heteroatoms such as O, S, N or P, and/or optionally substituted by one or more amine, alcohol, ketone, halogenated derivative, isocyanate, acetoacetonate, silanol, carboxylic acid ester and alcohol, epoxide, carbonate or mercaptan, phosphate, phosphonate, sulfate, sulfonate or carboxylate; and
F is an amino group, an alcohol, a ketone, a halogenated derivative, isocyanate, acetoacetonate, silanol, a carboxylic acid ester, a carboxylic alcohol, an epoxide, a carbonate or a mercaptan linked to the aromatic ring optionally by a straight or branched hydrocarbon chain, saturated or unsaturated having up to 100 carbon atoms.

15. The method of claim 1 wherein the cement product has a PSI of from 5 to 8.

16. The method of claim 15 wherein the cement product has a PSI of from 5 to 7.

17. The method of claim 5 wherein the defoamer is present and the defoamer is triisobutyl phosphate.

18. A method for grinding cement clinker particles, comprising:
determining the PSI of ground cement powder after the cement powder was ground in the presence of a grinding aid that did not comprise a polyacrylic acid polymer and adding polyacrylic acid to the grinding aid in an amount effective to increase the PSI greater than that obtained when the polyacrylic acid is not present in the grinding additive;
introducing an aqueous grinding additive to a dry composition comprising cement clinker particles, in a ball mill or roller mill, whereby said particles are ground to have a finer average particle size, wherein the aqueous grinding additive composition comprises:
from about 3 to about 5% by weight of at least one polyacrylic acid or a salt thereof, wherein the polyacrylic acid has a weight average molecular weight of from 1,500 to 25,000 g/mol; and
water; and
grinding the dry composition comprising the cement clinker particles and the aqueous grinding additive composition to produce a cement product having a pack set index (PSI) greater than that obtained when the polyacrylic acid is not present in the grinding additive.

19. The method of claim 18 wherein the aqueous grinding additive further comprises from about 0.5 to about 60% of at least one polycarboxylate ether comb polymer.

20. The method of claim 18 wherein the aqueous grinding additive composition further comprises at least one of a glycol, glycerol, a defoamer, sugar, salt, acetic acid or an acetate salt.

21. The method of claim 20 wherein glycol is present and the glycol comprises at least one selected from the group consisting of ethylene glycol, diethylene glycol, triethylene glycol, dipropylene glycol, and tripropylene glycol.

22. The method of claim 18 wherein the aqueous grinding additive composition further comprises a grinding additive selected from the group consisting of triethanolamine, triisopropanolamine, diethanolisopropanolamine, diisopropanolethanolamine, tetrahyroxyethylthylene diamine, an acetic acid or salt thereof, or mixtures thereof.

23. The method of claim 20 wherein the aqueous grinding additive comprises sugar at a concentration of from 0.1-50% by weight, salt at a concentration of from 0.1-50% by weight, the defoamer at a concentration of from 0.05-10% by weight, and acetic acid and/or acetate salt at a concentration of from 0.1-50% by weight.

24. The method of claim 1 wherein the PSI obtained when the polyacrylic acid is not present in the grinding additive is less than 3.
